(19) United States
(12) Patent Application Publication
(10) Pub. No.: US 2016/0061690 A1
(43) Pub. Date: Mar. 3, 2016

(54) NON-CONTACT METHOD OF MEASURING INSERTION LOSS IN OPTICAL FIBER CONNECTORS USING ACTIVE ALIGNMENT

(71) Applicant: CORNING OPTICAL COMMUNICATIONS LLC, Hickory, NC (US)

(72) Inventors: Robert Bruce Elkins, II, Hickory, NC (US); James Scott Sutherland, Corning, NY (US); Elvis Alberto Zambrano, Corning, NY (US)

(21) Appl. No.: 14/472,954

(22) Filed: Aug. 29, 2014

(51) Int. Cl. G01M 11/00

(52) U.S. Cl. CPC G01M 11/30

(57) ABSTRACT

A non-contact method of measuring an insertion loss of a device-under-test (DUT) connector is disclosed. The method includes arranging the DUT connector and a reference connector so that their respective ferrule ends are confronting and spaced apart. The method also includes moving the reference and DUT connectors closer together while measuring the insertion loss and while also actively maintaining alignment of the first and second ferrules using a position measurement system. The insertion loss for the DUT connector is obtained by estimating a value for the insertion loss at a position where the end faces of the reference and connector ferrules would come into contact.

### CROSS-REFERENCE TO RELATED APPLICATIONS

This application is related to U.S. patent application Ser. No. 14/447,133, filed on Jul. 30, 2014, which is incorporated herein by reference, and which is referred to below as “the '133 application.”

### FIELD

The present disclosure relates to optical fiber connectors, and in particular relates to a non-contact method of measuring insertion loss in optical fiber connectors using active alignment.

### BACKGROUND

Optical fiber connectors are used to optically connect one optical fiber to another. One parameter used to measure the quality of the optical fiber connection made by the optical fiber connector is the insertion loss (IL), which is a measure of how much light is lost when passing from one fiber to the other through the optical fiber connector. In some configurations, the optical fiber connector being evaluated is referred to as the device under test (DUT) connector, and the connector to which the DUT is connected is called the reference connector.

Current IL measurement methods used by most optical connector manufacturers require physical contact of the end faces of the DUT and reference connectors, or the use of an index matching fluid between them. This contact-based method requires cleaning and performing a visual inspection before and after the IL measurement. These steps are time consuming and they reduce productivity. The contact-based method also risks damaging the end faces of the fibers and ferrules of both the DUT and reference connectors.

To reduce the number of reworked or discarded connectors due to insertion loss failures, manufacturers have pursued reduced insertion loss by reducing core-to-ferrule alignment tolerances, but this has resulted in increased connector cost. Connector components manufacturers appear to have reached the limit of their technology to satisfy a market with continual demand for improvement. With the production of connectors increasing year after year to satisfy the market demand, there is a need for a more efficient, flexible and scalable method for inspecting optical fiber connectors.

### SUMMARY

Aspects of the disclosure are directed to a non-contact measurement method of the insertion loss of an optical fiber connector using active alignment. The method reduces the number of scrapped connectors resulting from end face damage and inspection costs associated with specialized reference jumpers that need to be replaced due to wear and tear from contact with the DUT connector. The non-contact inspection method also preserves a pristine surface for both the DUT and reference connectors.

Aspects of the methods disclosed herein are based on fundamental theories of optical coupling and they reduce measurement variability as compared to the traditional contact-based measurement methods. The methods disclosed herein also provide additional troubleshooting information that helps isolate sources of loss to individual connector components.

An aspect of the method includes moving the reference and DUT connectors towards each other while rapidly estimating the position where ferrule contact will occur while also actively aligning the reference and DUT ferrules and not allowing them to come into contact with each other by always maintaining a gap distance between the reference and DUT ferrules. The DUT connector insertion loss at the position where contact would occur (the contact position) is determined by measurements of the insertion loss as function of the gap distance and an extrapolation of the measurement data from the near-contact position to the contact position. Analysis of the measured insertion loss provides dynamic feedback on error conditions, prompting modification of measurement conditions for improved accuracy, and automation of repeat measurements if necessary.

An example method of measuring insertion loss using active alignment include the following steps:
a) Inserting the DUT connector into a mounting fixture of the measurement system.
b) Moving the ferrule of the reference connector (i.e., the reference ferrule) to a position where ferrule coaxial misalignment can be measured using a position measurement system (PMS).
c) Coaxially aligning the DUT ferrule with the reference ferrule using the PMS to perform active alignment.
d) Reducing the gap distance between the end faces of the reference and DUT ferrules while maintaining coaxial alignment using the PMS until a target near-contact axial gap distance is reached.
e) Estimating the DUT connector insertion loss using the measured optical power coupling data obtained at the near-contact position by extrapolating the data to the contact position.

Methods for determining a ferrule coaxial misalignment and ferrule end face gap distance include: using measured optical power coupled through the reference and DUT optical fibers of the DUT and reference connectors; using a vision system of the PMS; or using a laser profilometer of the PMS. In an example, a combination of these three methods can be employed.

In addition to measurement of the insertion loss of the DUT connector, the measurement system can also estimate: a) the DUT connector fiber core-to-ferrule lateral misalignment, and b) DUT connector IL minimum and maximum values when mated with reference connectors that have their fiber core positions distributed over a predefined range on the ferrule end face (e.g., keyhole specification).

An aspect of the disclosure is a non-contact method of measuring an insertion loss of a device-under-test (DUT) connector having a first ferrule with a first optical fiber and a first end face with a reference connector having a second ferrule with a second optical fiber and a second end face, comprising: axially aligning the first and second ferrules so that the first and second end faces are confronting and spaced apart to define a gap with an axial gap distance d; measuring values of the insertion loss between the first and second optical fibers for different gap distances d>0 μm while actively maintaining alignment of the first and second ferrules using a position measurement system; and estimating a value for the insertion loss for a gap distance of d=0 μm based on the measured values of the insertion loss when d>0 μm.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying Figures, in which:

FIG. 1 is a schematic diagram of an example measurement system for measuring the insertion loss between two optical fiber connectors using a position measurement system (PMS) to perform active alignment;

FIGS. 2A and 2B are close-up, cross-sectional views of example reference and DUT optical fiber connectors;

FIG. 3A is a close-up view of the portion of the measurement system of FIG. 1, wherein the alignment of the respective ferrules of the reference connector and the DUT connector is measured by the PMS as the gap distance d is varied during the insertion loss measurement process;

FIG. 3B is an elevated view of an example FC connector that can be either the reference or the DUT connector;

FIG. 3C is an elevated view of an example LC connector that can be either the reference or the DUT connector;

FIG. 4 is a plot of the simulated insertion loss IL (dB) versus the lateral misalignment δx (μm) for different gap distance d ranging from 0 μm to 6000 μm in 1000 μm increments;

FIG. 5 is a plot of the simulated insertion loss IL (dB) versus the angular misalignment δθ (degrees) for the same gap distances d of FIG. 4;

FIG. 6A is an example close-up image of the reference and DUT connectors as viewed by a viewing system of the PMS, wherein the gap distance d is about 800 μm;

FIG. 6B is similar to FIG. 6A but for the two connectors in contact, i.e., d=0.

FIG. 7A is similar to FIG. 6A and illustrates an example wherein the angular misalignments of the respective ferrules of the reference and DUT connectors are measured to obtain an estimation of the relative connector ferrule angle;

FIG. 7B is a close-up view similar to FIG. 6B, showing an estimation of the separation of the outer surfaces of the reference and DUT ferrules using the viewing system of the PMS wherein virtual reference points VPR and VPD are established to estimate a separation distance of the respective beveled edges of the two ferrules;

FIG. 8A is a upward looking view of an example position measuring system in the form of a scanning laser profilometer;

FIG. 8B is similar to FIG. 7A and shows the ferrules of the reference and DUT connectors respectively within the line scanning field of view;

FIG. 9 is a side view of an example test configuration showing mated LC reference and DUT connectors and the scanning laser profilometer scanning their respective ferrules;

FIG. 10A is a laser profilometer scan of a single LC connector ferrule end region showing the ferrule end bevel and ferrule outer-surface edge;

FIG. 10B is similar to FIG. 9A but with the vertical scale distance reduced to increase the plot resolution at the ferrule end;

FIG. 11A is a laser profilometer scan of mated LC reference and DUT connectors, overlaid with linear extrapolations of the ferrule outer-surface edges to determine ferrule-to-ferrule misalignment;

FIG. 11B shows an example laser profilometer scan of a single LC connector ferrule overlaid with linear extrapolations from ferrule end bevel outer-surface edges to create a virtual reference point;

FIG. 12 is similar to FIG. 11A and illustrates the determination of two virtual reference points VPR and VPD along with the estimated ferrule-to-ferrule separation for confronting reference and DUT ferrules based on the two virtual reference points;

FIG. 13 is a plot of the measured insertion loss IL (dB) versus gap distance d illustrating how contamination on the ferrule end face can change the periodicity of the IL fringe pitch; and

FIG. 14 is similar to FIG. 13 and illustrates insertion loss data for estimating DUT IL at an estimated contact position using a set of near-contact IL minima points and a parabolic fit to the minima points over the measurement range to extrapolate to the estimated contact position.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure.

In the discussion below, the term “optical fiber connector” is referred to as “connector” for short.

Also in the discussion below, IL stands for “insertion loss” while IL_{M} stands for “measured insertion loss.” Further, P_{C} stands for the contact position of the stage 80 when the ferrule end faces of the DUT and reference connectors are in contact, i.e., for the condition d=0 μm.

It is noted that discussion of the reference and DUT connectors being in contact refers to aspects of the method where the insertion loss is estimated for the condition wherein the DUT and reference connectors would be in in contact, and that the two connectors are not actually brought into contact during the method.

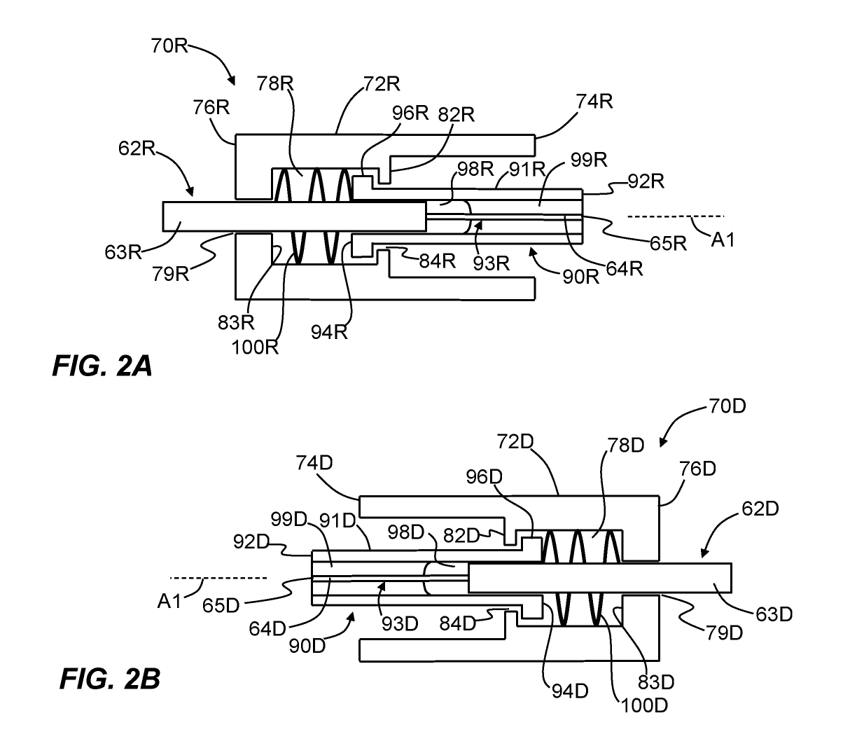

The non-contact active alignment methods disclosed herein are presented by way of example and ease of discussion by considering SMF-28 single-mode fiber SC-UPC type connectors such as shown in FIGS. 2A and 2B, introduced and discussed below. However, the methods are broadly applicable to a wide range of optical interconnection configurations and device types, including: connectors with any type of single-mode fiber, such as SMF-28, DS and LS; connectors with any type of multimode fiber, such as for 50 μm and 62 μm core diameter, step index and graded index core profiles; connectors with flat (UPC) or angled (APC) ferrule end faces; connectors that use any kind of passive alignment feature (SC, FC, ST or LC type connector) or member that maintains core pin and hole-based connectors, such as MTP and MT-RJ configurations.

In addition, the methods disclosed herein are applicable to connectors attached to any type of photonic device besides optical fibers, such as passive devices like jumper cables, splitters, filters, etc., and active devices like laser sources, switches, modulators, etc. The methods can also be applied to non-connectorized devices, such as bare fibers, large diameter fibers, multicore fibers, and fibers in fiber splicers.

Non-Contact Measurement System with Active Alignment

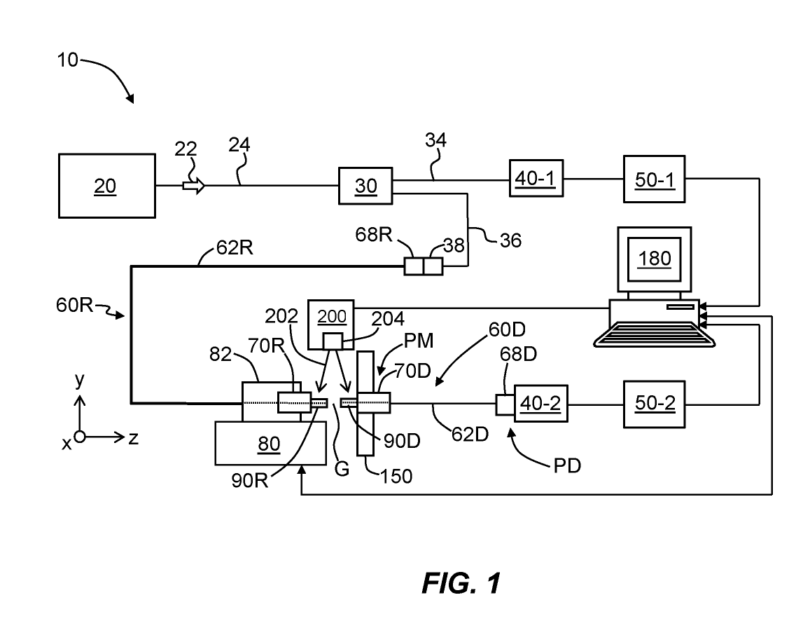

FIG. 1 is a schematic diagram of an example non-contact insertion loss measurement system (“system”) 10 for carrying out the active-alignment IL measurement methods disclosed herein. The system 10 includes a laser source 20 that emits light 22 of wavelength λ, which can be any of the wavelengths used in optical communications, e.g., 850 nm, 1330 nm, 1550 nm, etc. Laser source 20 is optically coupled to a splitter 30 via an optical fiber section 24. The splitter 30 is optically coupled to a first detector 40-1 (e.g., via an optical fiber section 34). First detector 40-1 in turn is electrically connected to a first power meter 50-1. In an example, splitter 30 is a 50:50 splitter.

The splitter 30 is also optically connected to a reference jumper cable 60R, e.g., via an optical fiber section 36 that includes a connector 38. Reference jumper cable 60R includes an optical fiber 62R that includes at one end a connector 68R that engages with connector 38 of optical fiber section 36, and includes at the other end a connector 70R, which is referred to hereinafter as the “reference connector,” and which is described in greater detail below. The reference connector 70R is supported by a support fixture 82 of a computer-controlled precision stage (“stage”) 80, which is configured to move the reference connector in the three spatial directions (x, y and z) as well as in at least two angular rotation directions (θₓ and θ_{y}). A third angular rotation direction (θ_{z}) may be provided in some embodiments, for example, when using the system 10 for IL measurements of connectors that include multiple optical fibers (in 1D or 2D arrays), and/or in optical fibers that require rotation alignment about the optical axis (e.g., polarization-dependent fibers and multicore fibers).

FIGS. 2A and 2B are cross-sectional views of example reference and DUT connectors 70R and 70D. With reference to FIG. 2A, reference connector 70R includes a ferrule 90R having an outer surface 91R and a front end or end face 92R. The reference ferrule 90R includes a longitudinal bore 93R that supports a bare section 64R of optical fiber 62R, with the bare section 64R having an end face 65R at a ferrule front end (or end face) 92R.

Likewise, with reference to FIG. 2B, DUT connector 70D includes a ferrule 90D having an outer surface 91D and a front end or end face 92D. The DUT ferrule 90D includes a longitudinal bore 93D that supports a bare section 64D of optical fiber 62D, with the bare section 64D having an end face 65D at a ferrule front end (or end face) 92D. The bare sections 64R and 64D of reference and DUT optical fibers 62R and 62D are referred to below as “bare fiber sections.”

With reference again to FIG. 1, system 10 also includes a mounting fixture 150 that operably supports DUT connector 70D, which in an example is part of a DUT cable 60D that includes DUT fiber 62D. In an example, mounting fixture 150 defines a measurement port PM that accommodates DUT connector 70D. The DUT fiber 62D is optically connected to a second detector 40-2 via a connector 68D. In an example, second detector 40-2 defines a detector port PD that accommodates connector 68D. The use of measurement and connector ports PM and PD facilitates the insertion and removal of DUT cable 60D to and from system 10. The second detector 40-2 is electrically connected to a second power meter 50-2. The first and second power meters 50-1 and 50-2, along with stage 80, are operably connected to a controller (or computer) 180. Thus, in an example, translational and rotational motions of stage 80 are controlled by controller 180.

The support fixture 82 and mounting fixture 150 are arranged so that the respective ferrule front ends 92R and 92D (and thus the respective fiber end faces 65R and 65D) face one another (i.e., are confronting) and define a gap G, wherein the end faces are spaced apart by an axial distance d, referred to below as the gap distance. Because stage 80 is axially movable, the gap distance d is adjustable. It should be noted that, if necessary, the connector mounting configuration can be reversed, so that the DUT connector 70D is mounted on moveable stage 80, while the reference connector 70R is mounted on an immovable mounting fixture 150.

System 10 further includes a position measuring system (PMS) 200 arranged to view or otherwise inspect ferrule front ends 92R and 92D and gap G therebetween. The PMS 200 is operably connected to controller 180. In an example, PMS 200 include a viewing system 204, which in one example is or includes a machine vision system, while in another example is or includes a laser profilometer system. Methods of measuring the insertion loss using these two viewing systems 204 are discussed in greater detail below.

A suitable light source 20 is a laser source, such as the Greenlee Model 580XL, that operates at either 1550 nm or 1310 nm. Suitable first and second detectors 40-1 and 40-2 are Newport 918-IS-I, 850-1600 nm broad-area detectors. Suitable first and second power meters 50A and 50B are Newport 1936-R power meters having a single channel and a USB interface. A suitable splitter 30 is the ThorLabs 2×2 Single Mode Fused Fiber Optic Coupler/Tap. Suitable fixtures 82 and 150 for holding reference connector 70 and DUT connector 70 include Newport 561-SCH SC Connector Holders. A suitable stage 80 is the Newport 562-XYZ ULTRAIign™ Fiber Alignment Stage, and motorized stage actuators include the Newport LTA-HS Actuator. An example motion stage controller is the Newport ESP-301 3-Axis Motion Controller.

Other suitable elements of system 10 include Analog USB Chassis from National Instruments, NI cDaq-9184, an Analog Module from National Instruments, NI USB-9239, 4-channel input. Computer 180 can be PC controller such as the Advantec PC that runs LabView 2012 SP2 and Windows Office 2010.

As noted above, FIGS. 2A and 2B are close-up, cross-sectional view of example reference and DUT connectors 70R and 70D, respectively. In the discussion above and below, connector components of reference connector 70R include an “R” in the reference number while connector components of DUT connector 70D include a “D” in the reference number. When referring to a connector 70 in general (i.e., elements/aspects common to reference connecter 70R and DUT connector 70D), the “D” and “R” suffix in the reference numbers is omitted. The same applies to optical fiber 62R and DUT fiber 62D.

With continuing reference to FIGS. 2A and 2B, connector 70 includes a housing 72 having a central axis A1, an open front-end 74, a back end 76 and an interior chamber 78 adjacent the back end. Housing back end 76 includes an aperture 79. The interior chamber 78 is defined in part by front and rear chamber walls 82 and 83 within housing 72, with the front chamber wall having an aperture 84. Connector 70 also includes the aforementioned ferrule 90, which has a front end (end face) 92 and a back end 94 having a flange 96. The ferrule 90 has a longitudinal bore 98 that extends from back end 94 to front end 92 and that supports the bare fiber section 64 of optical fiber 62.

The ferrule 90 is arranged in housing 72 along central axis A1, with the flanged back end residing with interior chamber 78 and the ferrule extending through aperture 84, with the ferrule front end 92 extending from housing open front end 74. The optical fiber 62 includes a jacketed section 63 and the bare fiber section 64. The optical fiber 62 passes through aperture 79 at the back end 76 of housing 72 and extends through interior chamber 78 and into ferrule 90, with the jacketed section 63 extending partway into ferrule bore 98. The bare fiber section 64 extends to the front end 92 of ferrule 90 and is supported within the ferrule bore 98 by a bonding material 99. A resilient member 100 (e.g., a spring) resides in interior chamber 78 and contacts the rear chamber wall 83 and the flanged back end 94 of ferrule 90. In connector 70, ferrule 90 is mechanically decoupled from connector housing 72 by resilient member 100.

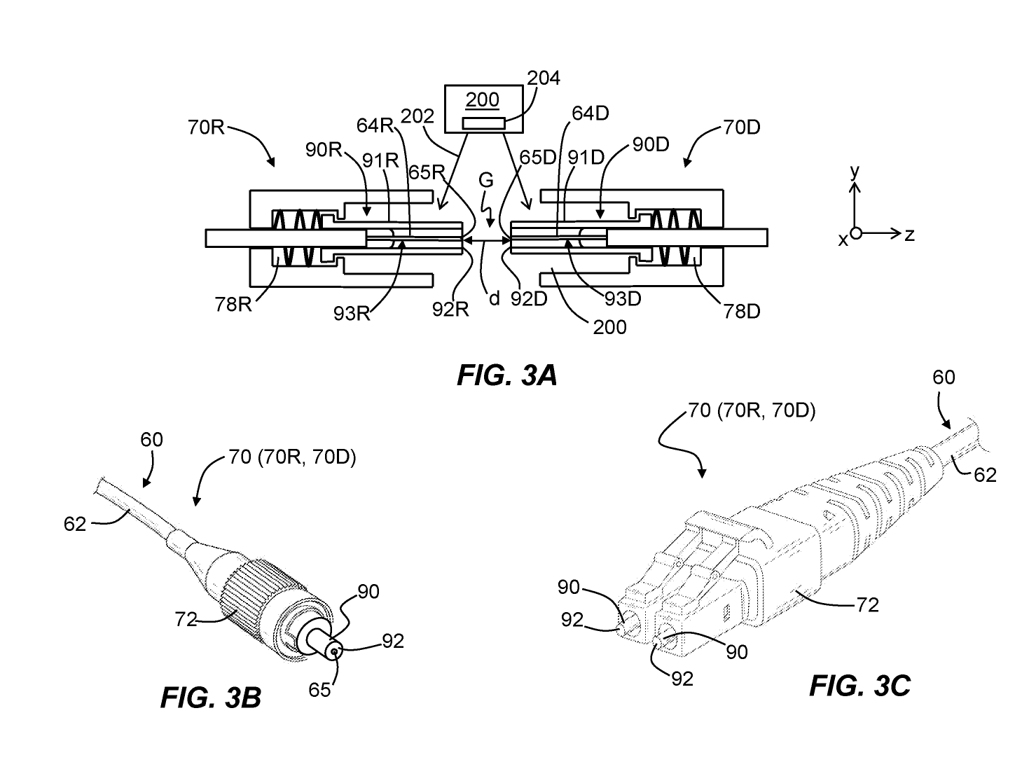

FIG. 3A is a close-up view of the reference connector 70R and DUT connector 70D operably arranged with their respective ferrules 90R and 90D in a substantially aligned and confronting configuration and within a field of view (FOV) or measurement range 202 of viewing system 204. When an axial compression force is applied on ferrule front ends 92R and 92D, the respective resilient members 100R and 100D compress, and the ferrules retract into their respective interior chamber 78R and 78D.

FIG. 3B is an elevated view of an example FC connector 70 that can be the reference or DUT connector. FIG. 3C is an elevated view of an example LC connector 70 that can be the reference or DUT connector.

In conventional insertion loss measurement methods, when the reference and DUT connectors 70R and 70D are moved toward each other, the respective ferrule end faces 92 meet and are forced into contact (i.e., the gap distance d becomes zero). In this case, an additional axial compression force is typically applied to drive the ferrule end faces 92R and 92D into firm contact. This additional force leads to additional compression of resilient members 100R and 100D.

System 10 is configured to perform a non-contact insertion loss measurement and provide for precisely adjusting the gap distance d of the ferrule front ends 92R and 90D (and thus the respective fiber end faces 65R and 65D) of the reference and DUT connectors 70R and 70D using active alignment. In the example configuration of system 10, the reference connector 70R is mounted on stage 80 using fixture 82 so that the stage's z-axis is substantially parallel to the connector ferrule axis. The DUT connector 70D can be fixed in place during the measurement method. In an example configuration of system 10, the DUT connector 70D is mounted in fixture 150, which can be positioned on a front panel (not shown) of the measurement system.

The DUT connector 70D may be attached to mounting fixture 150 by gripping a portion of ferrule 90D or alternatively by gripping a portion of the connector housing 72D. Gripping ferrule 90D may be difficult because of its small size. Therefore in the most general case, the DUT connector 70D is gripped by making contact with molded features (not shown) of its connector housing 72D. These features may include molded depressions and/or tabs that are normally engaged by adapter fingers or clips to retain the DUT connector inside an adapter and hold the two connector end faces in contact.

System 10 is configured to measure the amount of light 22 coupled from reference bare fiber section 64R associated with reference connector 70R into the DUT bare fiber section 64D associated with DUT connector 70D as the respective ferrules 90R and 90D are moved closer to each other as PMS 200 monitors the alignment of the two ferrules. In the operation of system 10, light 22 from light source 20 is directed though splitter 30 so that a portion of the light may be monitored over time at first detector 40-1. The other portion of light 22 from splitter 30 is directed to reference jumper cable 60R via a low-back-reflection optical connector 68. This light passes 22 through the reference jumper cable 60, exits reference bare fiber section 64R at its end face 65R and then propagates through gap G over the distance d to DUT connector 70D and to the end face 65D of DUT bare fiber section 64D. The coupled light then propagates down the DUT optical fiber 62D of the DUT jumper cable 60D and exits at a second DUT connector 68D and is then measured by second detector 40-2.

System 10 samples the two measured power levels P₁ and P₂ at detectors 40-1 and 40-2, respectively, and calculates a measured insertion loss IL, defined as IL_{M}=−10 log₁₀ (P₂/P₁). This calculation takes place in computer (controller) 180. This measured insertion loss value IL_{M} is repeatedly taken over the course of the measurement process for different values of d, with the measured values correlated with corresponding time and/or stage position measurements and/or values of the gap distance d.

When the DUT connector 70D is initially inserted into system 10, the reference connector 70R and its ferrule end 92R may be retracted away from the measurement region defined by FOV 202 to protect it from damage. A movable dust cover or other protective gate or member (not shown) may be initially positioned between the DUT connector ferrule 90D and the reference connector ferrule 90R. This cover or gate can prevent debris or contamination from falling on the reference connector ferrule end face 92R, either before or during insertion of DUT connector 70D.

For a large gap distance d, the gap G may need to be initially reduced to bring both reference and DUT ferrules 90R and 90D into the measurement range of PMS 200. The two ferrules may also be laterally misaligned by an excessively large value at the outset.

The measurement system must move the reference connector 70R toward the DUT connector 70D so that the reference and DUT ferrules 90R and 90D enter the measurement region defined by FOV 202 of viewing system 204 of PMS 200. Feedback from PMS 200 can direct controller 180 to terminate the movement of reference connector 70R once the reference ferrule 90R enters the measurement region. Optical feedback from light coupled through the reference and DUT connectors 70R and 70D can also provide information on the relative proximity of the reference and DUT ferrule end faces 92R and 92D. For example, the ferrule gap distance d can be reduced until the measured insertion loss reaches some low threshold value, such as 30 dB. This value would be small enough to ensure that the reference and DUT ferrules 90R and 90D never make physical contact. This approach assumes that reference and DUT ferrules 90R and 90D would at least be coarsely laterally and angularly aligned.

### Insertion Loss Characterization

In the jumper cable manufacturing process, the insertion loss for each connector 70 must be characterized individually. In an example, system 10 disclosed herein is configured with two connector ports PD and PM that respectively receive the connectors 68D and 70D on the two ends of a single DUT jumper cable 60D. The measurement port PM is where the insertion loss of the inserted connector 70D is characterized. The detector port PD is where the optical power coupled into the optical fiber via the measurement port PM is measured.

To characterize the insertion loss for a DUT jumper cable 60D, both connectors 68D and 70D must be measured. If one jumper cable connector is designated connector A and the other jumper cable connector is designated connector B, the jumper cable is characterized in two steps:
1) Measure IL of jumper cable connector A by inserting it into measurement port PM, and insert jumper cable connector B into detector port PD.
2) Measure the insertion loss of jumper cable connector B by inserting it into measurement port PM, and insert jumper cable connector A into detector port PD.

System 10 can be used to characterize devices that provide a 1:N optical split function, where the N splitter output connectors are attached to the measurement system in N separate measurements. A variety of other connectorized passive and active optical devices that can be characterized using the measurement approach are discussed below.

After each connector insertion loss measurement, system 10 can also make an estimate of insertion loss associated with the jumper cable optical link between its connectors, as described below. Unless otherwise noted, in this document, a DUT measurement refers to the insertion loss measurement performed on a single jumper cable connector 70D.

To measure each jumper cable connector insertion loss, a user must first remove both connector dust caps and clean both connector ferrule ends to remove unwanted debris that may remain there after previous processing steps. The cleaning process may be manual or automated.

After cleaning, the fiber end 65D and ferrule end 92D are visually inspected to ensure that all debris has been removed. While the near-contact measurement methods disclosed herein prevent reference and DUT ferrules 90R and 90D from touching each other within system 10 during an insertion loss measurement, the gap G can be small, such as d=5 μm. Since this gap distance d can be smaller than the size of many common debris items (e.g., lint, dirt, dust), the debris on the fiber end face 65D can inhibit correct measurement of DUT insertion loss. Debris can also block light transmission into the DUT connector fiber core, resulting in an inaccurate measurement of DUT insertion loss.

Since the measurement methods can depend on an optical characterization of the positions of the outer surfaces 91R and 92D of the reference and DUT ferrules 90R and 90D, the measurement methods are improved when contamination is removed from all ferrule outer surfaces.

After connector cleaning, the connectors 68D and 70D of DUT jumper cable 60D are manually inserted into system 10 and the detector ports PD and PM respectively. In an example, system 10 can have an ambient environment that is held at a slight positive pressure within an enclosure (not shown) relative to the surrounding environment to prevent airborne debris from the surrounding environment from entering system via the measurement and detector ports. In an example, system 10 is mounted on vibration isolation device to minimize the influence of environmental vibrations on optical measurements.

The DUT Jumper cable connectors 68D and 70D may be retained in the measurement system ports PD and PM using a variety of techniques, including using passive clips integral to the ports that mate with depressions on the connector housings 72, similar to the way connectors are currently held in adapter housings. Alternatively, the DUT jumper cable connectors 68D and 70D may be contacted by one or more mechanically actuated arms, grippers or pistons that engage with connector body depressions to hold the connector body in a known position during the DUT measurement.

The connector gripping action can be single-sided, so that the connector is forced into contact with a reference surface that is internal to the port housing. Alternatively, the connector gripping action can be double-sided, so that the connector body is centered within the port housing. The gripping action can be provided in a single lateral direction (such as in the x-direction, where the z-direction is the fiber axis), or in two lateral directions (such as the x-direction and the y-direction). The mechanical actuation motion may be provided by a computer-controlled pneumatic system.

The reference connector 70R may be mounted within system 10 using passive or actuated mounting methods and features for fixture 82, similar to the ones used to grip the DUT connector housing 72D. This allows users to periodically inspect and replace reference connectors and sleeves quickly and easily.

### Active Coaxial Alignment Methods

An aspect of the measurement methods disclosed herein includes establishing coaxial alignment of the DUT connector ferrule 90D with a reference connector ferrule 90R within system 10 using active alignment. This coaxial alignment can be provided early or late in the measurement process. Since the center of the fiber core may be misaligned from the center of the ferrule end face 65, coaxial alignment of connector ferrules does not necessary imply perfect coaxial alignment of connector optical fiber cores.

In early coaxial alignment, the reference and connector ferrules 90R and 90D are coaxially aligned while separated by a large axial distance (i.e., large gap distance d). The large axial separation ensures that any angular rotations of the reference ferrule 90R will not result in unintended ferrule-to-ferrule contact. After ferrule coaxial alignment, the ferrule gap distance d is reduced until the ferrules are nearly in contact. In this approach, the reference ferrule 90R is guided down a “virtual” alignment sleeve toward the DUT ferrule 90D, where it is constantly held in coaxial alignment via feedback from PMS 200 and/or the coordinated motion of stage 80. This approach mimics the passive alignment approach described in the '133 application but without requiring the use of an alignment sleeve.

In late coaxial alignment, the reference and DUT connector ferrules 90R and 90D are first moved so that that there is a relatively small gap distance d, without regard to their degree of coaxial misalignment. The ferrule gap distance d at the end of motion may be larger than a typical near contact distance (e.g., 5 μm) so that, when the two ferrules are coaxially aligned, any required ferrule rotations will not lead to ferrule-to-ferrule contact. The ferrule gap distance d may be monitored using feedback from light coupled through the connectors and/or via PMS 200. This approach is more similar to the way fiber splicers align fiber cores prior to splicing.

The discussion below describes processes for coaxial alignment that are applicable to both early and late coaxial alignment. It should be understood that other ferrule alignment methods can be employed, such as: a) methods that perform coaxial alignment continuously as the ferrule gap is reduced; b) methods that perform coaxial alignment and ferrule gap reduction in alternating steps, traversing multiple zones and moving from rapid and low accuracy alignment methods to slower but more accurate alignment methods; c) methods that decompose coaxial alignment into two steps, namely i) a paraxial alignment step, where the axes of the two ferrules are made parallel but not necessarily coaxial wherein the ferrule end faces should be approximately parallel, and ii) a lateral alignment step where the two paraxial ferrule axes are brought into coaxial alignment. These two alignment steps can be carried out in either order, or simultaneously.

In other examples, the order of the various alignment methods is varied. For example, the following order can be employed where three different alignments are performed in sequence: 1) paraxial alignment of reference and DUT ferrules 90R and 90D while separated by a large ferrule gap distance d; 2) ferrule gap distance reduction until the ferrule end faces 92R and 92D are nearly in contact (e.g., 5 μm gap in between); and 3) lateral alignment to bring the reference and DUT ferrules 90R and 90D into coaxial alignment.

### Active Coaxial Alignment Using Measured Optical Power

An example method of establishing coarse coaxial alignment of reference and DUT ferrules 90R and 90D involves moving the reference connector ferrule through a series of lateral and angular misalignments without varying the ferrule gap distance d. During these ferrule motions, the amount of light coupled into the DUT bare fiber section 64D from the reference bare fiber section 64R will vary. The maximum power coupling into the DUT fiber connector will occur when the DUT bare fiber section 64D is laterally and angularly aligned to the reference bare fiber section 64R. This maximum power condition corresponds to the configuration where the reference and DUT bare fiber sections 64R and 64D are coaxially aligned.

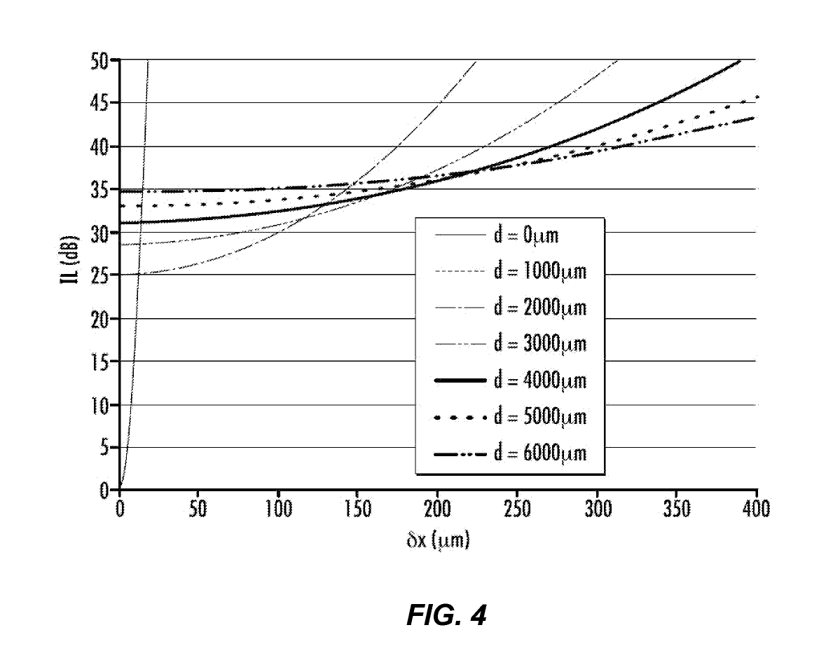

Unfortunately, at large gap distances d, the coupling efficiency is relatively insensitive to lateral misalignments. FIG. 4 is a plot of the insertion loss IL (dB) versus the lateral misalignment δx (μm) for various gap distances d ranging from 0 (contact position) to d=6000 μm for a pair of SMF-28 optical fibers at 1550 nm. It shows relatively flat IL curves near zero lateral misalignment (i.e., near δx=0) for relatively large gap distances, e.g., about d=20 μm or greater. Still, measurements may be made at various lateral misalignments δx so that a curve may be fitted to measured data to predict the minimum IL position corresponding to zero lateral misalignment. While this approach will be inaccurate at large axial separations d, accuracy will increase as the gap distance d is reduced.

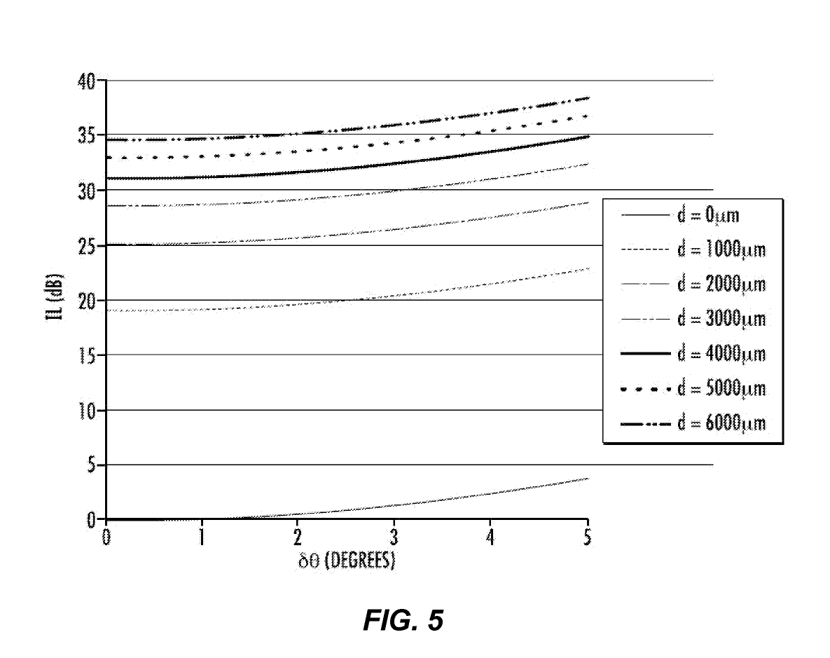

FIG. 5 plots IL (dB) versus angular misalignment δθ (degrees) for the same range of gap distances d as in FIG. 4. As with the lateral misalignment plots, the flat IL response near zero angular misalignment will make it difficult to establish angular alignment with high accuracy, even at small gap distances d.

### Active Coaxial Alignment Using a Vision System

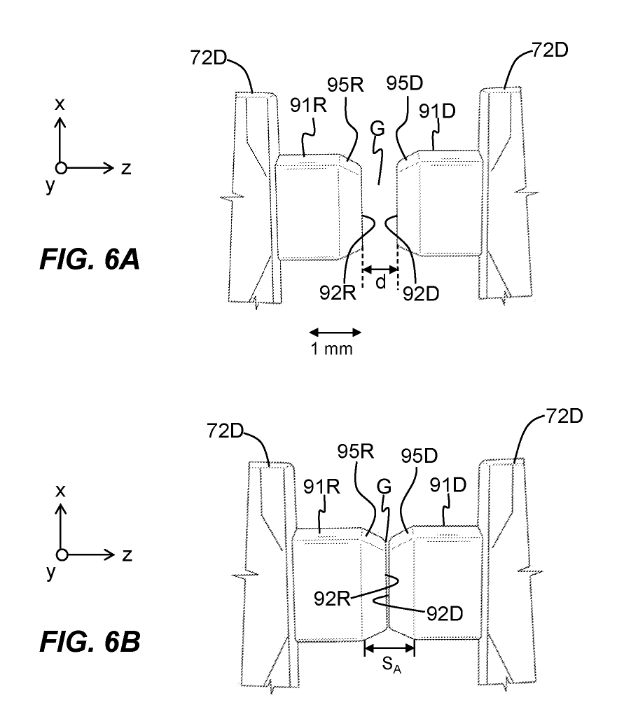

In an example embodiment, viewing system 204 of PMS 200 includes a vision system wherein the FOV 202 provides a view (image) of the reference and DUT ferrules 90R and 90D as they approach each other. In an example, FOV 202 is sized to accommodate ferrules 90 having a diameter of up to 2.5 mm. FIG. 6A is an example top-down, close-up image of the reference and DUT ferrules 90R and 90D as seen by the vision system of PMS 200 looking in the −y direction and with a gap distance d of about 800 μm. The reference and DUT ferrules 90R and 90D have respective beveled edges (“bevels”) 95R and 95D.

A complication that comes with imaging reference and DUT ferrules 90R and 90D is that light scattered from the ferrule outer surface 91 can reduce the optical contrast when viewing the confronting reference and DUT ferrule end faces 92R and 92D. This reduction in contrast is compounded by the fact that much of the scattered light originates from surfaces outside the vision system depth of field (DOF), resulting in image blur and contrast reduction. Note that when viewing ferrule 90 with viewing system 204 that the outer surface 91 appears as an edge, so that the outer surface is also referred to below as the outer-surface edge 91.

Paraxial and coaxial alignment of reference and DUT ferrules 90R and 90D require the imaging of both reference and DUT ferrule end faces 92R and 92D. Typical UPC (Ultra Polished Connector) ferrule end faces 92 include the aforementioned perimeter bevel 95 that can extend 0.5 mm or more away from the ferrule end face 92. Thus, even when reference and DUT ferrule end faces 92R and 92D are in contact, the outer surfaces 91R and 91D of the reference and DUT ferrules 90R and 90D remain separated by a separation distance S_{A} of least 1 mm due to bevels 95R and 95D. This is illustrated in FIG. 6B, which is similar to FIG. 6A but with the reference and DUT ferrule end faces 92R and 92D in contact (i.e., gap distance d=0).

Since the vision system of PMS 200 requires FOV 202 to extend a sufficient axial length (e.g., >250 μm) along each ferrule 90R and 90D, the total FOV of view must be large enough to include a portion of outer surfaces 91R and 91D even when the two ferrules are separated by a large gap distance d. A large FOV 202 can reduce the accuracy of the estimation of the position of ferrule end faces 92R and 92D, so in an example, the viewing system has a suitably high pixel count to provide the desired resolution of the end face positions over the FOV 202.

When the outer surfaces 91R and 91D of reference and DUT ferrules 90R and 90D appear in the image field, image processing edge detection routines that run in controller 180 can be used to estimate the angle of a line that runs parallel to the ferrule outer surface. In an example, the image processing routines can include one or more of the following operations, wherein the ferrule outer surface appears as an edge:
Increasing the image contrast to make the end faces appear clearer.
Performing a pixel threshold operation to separate end face from non-end-face pixels.
Performing a linear interpolation of pixel intensity along a line roughly perpendicular to the ferrule outer surface in the image, followed by a threshold limit, yielding sub-pixel estimation of the position of the outer-surface edge.
Performing a linear interpolation of each detected outer-surface edge location using any of the edge detection approaches described immediately above, resulting in a line that represents the ferrule outer-surface edge.

Once the ferrule outer-surface edge line has been determined for the reference and DUT ferrules 90R and 90D, the angle between the two lines can be measured to estimate the degree of angular misalignment away from paraxial alignment for the two ferrules in each of the two lateral viewing planes (i.e., the x-z plane and the y-z plane).

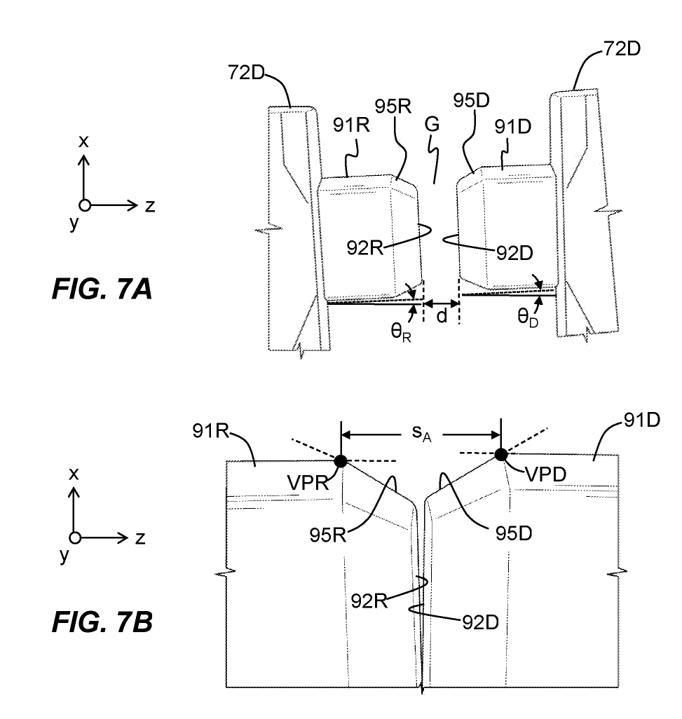

FIG. 7A is similar to FIG. 6A and shows the reference and DUT connector ferrules 90R and 90D as viewed looking in the −y direction and thus in the x-z plane. The vision system can determine ferrule angles θ_{RX} and θ_{DX} relative to the vision system z-axis by generating linear interpolations for each ferrule outer-surface edge 91R and 92D, shown as dashed lines. By subtracting θ_{DX} from θ_{RX}, an estimation of relative connector ferrule angle θ_{CX}=θ_{RX}−θ_{DX} can be made for the vision system in the x-z plane. A similar measurement can be made for the y-z plane to obtain θ_{CY}=θ_{RY}−θ_{DY}.

In one aspect of the active alignment method using PMS 200, the PMS includes multiple viewing systems 204 that view reference and DUT ferrules 90R and 90D from orthogonal directions, i.e., along the y direction and along the x direction. In addition, each of the viewing systems can be mounted on precision motion stages. Since precision motion stages can be translated while minimizing lateral misalignment, this approach enables separate viewing of each ferrule outer-surface edge, followed by stitching together of measured images to provide an overall estimate of ferrule-to-ferrule θₓ and θ_{y} angular misalignment.

In an example embodiment, viewing system 204 of PMS 200 can provide coarse coaxial alignment of the reference and DUT ferrules 90R and 90D in a rapid process that may complement other more precise coaxial alignment techniques. For example, the viewing system 204 in the form of a vision system can be used to provide coarse alignment to prepare fibers for more accurate angular or lateral misalignment using the optical coupling technique, in an approach that could also observe ferrule end face positions to ensure that they never make contact.

The gap distance d can also be estimated using the vision system of viewing system 204 to determine the corner point (in the vision system view) between the ferrule outer-surface edge and the ferrule end bevel 95. FIG. 7B is a close-up view of reference and DUT ferrules 90R and 90D in contact and showing linear interpolation fits as dashed lines (as determined by edge-detection image processing) for the reference ferrule outer-surface edge 91R and the corresponding bevel 95R. The point where these two lines intercept creates a virtual reference point VPR that can serve as a reference location for reference connector ferrule 90R. The same approach can be used to generate a virtual reference point VPD for DUT ferrule 90D. The vision system calculates the distance S_{A} between these reference and DUT virtual reference points VPR and VPD and subtracts and offset to compensate for the axial length associated with the ferrule bevels. The resulting value provides an estimate of the ferrule gap distance d. Variations in the calculated locations of virtual reference points VPR and VPD can be used to predict lateral misalignments for the two ferrules.

As mentioned above, in an example the method of active coaxial alignment of reference and DUT ferrules 90R and 90D can be broken into two separate alignment processes: a paraxial alignment and a lateral alignment. While the resolution limits associated with vision systems may not make it possible to resolve sub-micrometer variations in ferrule lateral position (using the edge detection methods described above), it is well-suited for making highly accurate measurements of angular alignment of the two ferrules. This is because the angular measurement can be made along a long edge of the outer surface of the ferrule, so that the edge position can be estimated at each pixel position along the length of the outer-surface edge using the techniques described above.

### Active Coaxial Alignment Using a Laser Profilometer

In an example embodiment, viewing system 204 of PMS system 200 includes a laser profilometer. A laser profilometer is capable of providing sub-micrometer non-contact measurements of surface profiles. They commonly operate in a confocal mode, where a high numerical aperture (NA) and relatively broad laser beam is focused down to a micrometer-scale spot. The focus position of the beam along the optical axis is changed rapidly by mounting the laser optics on a vibrating tuning fork. When the beam is directed onto a planar surface, its diameter on the surface rapidly changes from large to small to large again as the beam focus position passes through the surface. A photo-detector integrated with the profilometer measures the variation in the intensity of scattered light with time, and correlates this data with the expected beam focal spot axial position determined via tuning fork displacement. When the intensity profile is at a minimum the beam is known to be focused on the planar surface. Since the tuning fork amplitude and frequency can be determined very accurately, a corresponding accurate estimate of surface profile displacement can be made. An example laser profilometer suitable for use in system 10 is the Keyence LT-9010 scanning laser profilometer, available from the Keyence Corporation of America, Itasca, Ill.

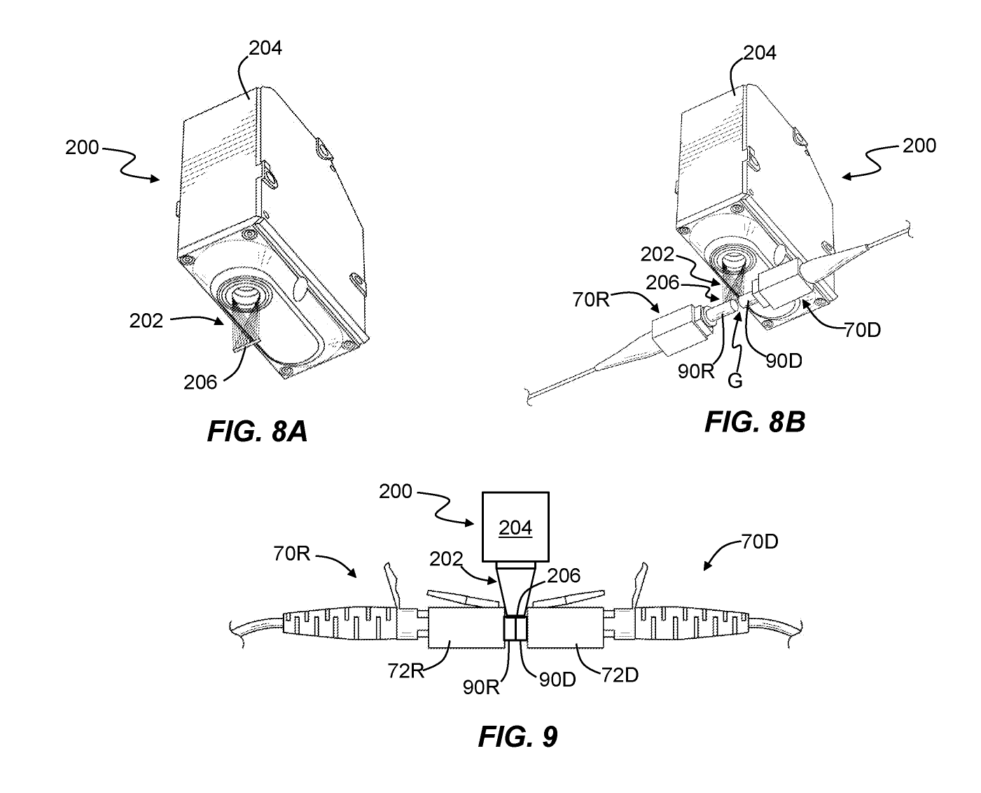

FIG. 8A is an upward looking view of an example PMS 200 that includes a scanning laser profilometer, while FIG. 8B is similar to FIG. 8A shows the reference and DUT connectors within the FOV 202 of the laser profilometer. The laser profilometer is configured to measure the surface profile of the confronting but spaced-apart reference and DUT ferrules 90R and 90D. The laser scan line 206 of the laser profilometer that defines FOV 202 is also shown.

FIG. 9 is a side view of an example test configuration of system 10 showing mated LC reference and DUT connectors 70R and 70D and the scanning laser profilometer of PMS 200. The LC reference and DUT connectors 70R and 70D in FIG. 9 were selected so that critical ferrule end features would fall within the scan distance of 1.1 mm. The reference and DUT connectors 70R and 70D were roughly aligned to each other and then temporarily attached to a common flat stage using adhesive tape.

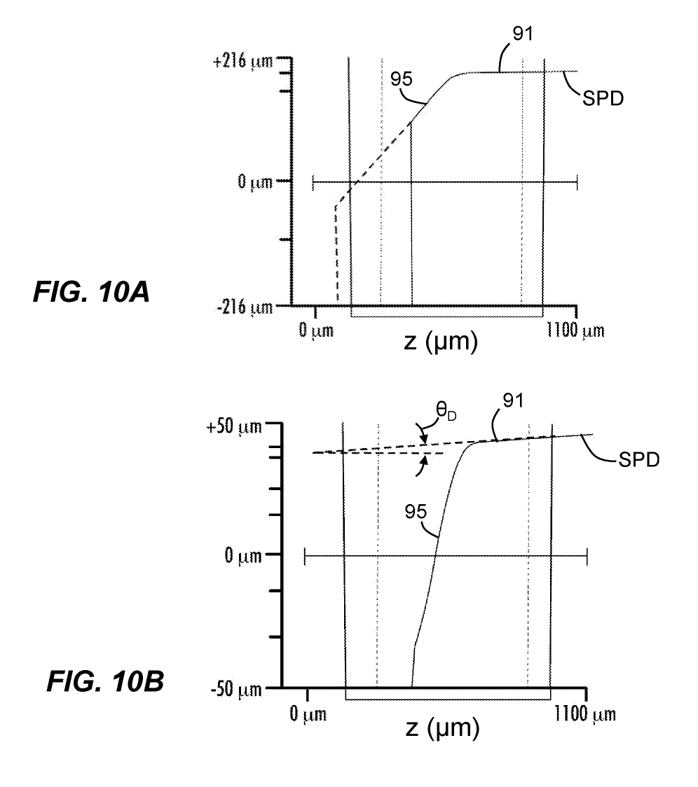

The laser profilometer of viewing system 204 was aligned to the mated reference and DUT connector ferrules 90R and 90D so that the laser beam swept back and forth across the ferrule-ferrule interface approximately parallel to the ferrule axes. FIG. 10A shows the resulting plot from the laser profilometer with the surface profile shown as the solid black line and the predicted ferrule end face profile shown as a dashed line. The plot demonstrates that the laser profilometer can resolve key features of the connector ferrule end 92, even when the ferrule surfaces are angled relative to the laser profilometer. For example, both the ferrule outer-surface edge 91 and the ferrule end bevel 95 are clearly visible in the plot.

The profile from the laser profilometer is shown to drop about 40% down the ferrule end bevel 95. The laser profilometer works by measuring the amount of light backscattered from the measurement location. The profile data may drop off because the scan path of the laser beam generated by the laser profilometer is not sufficiently aligned directly over the ferrule axis, causing the surface angle to become too steep so that insufficient light is backscattered to the profilometer.

FIG. 10B is similar to FIG. 10A and shows the same ferrule end measurement as shown in FIG. 10A, but where the vertical scale distance has been reduced to increase plot resolution at ferrule end face 92. The ferrule outer-surface edge angle can be measured by first performing a linear interpolation of measured surface profile points along the ferrule outer-surface edge 91. Next the angle between the line and the scanning laser profilometer reference plane is determined. This provides a relative measurement of the ferrule end face angle.

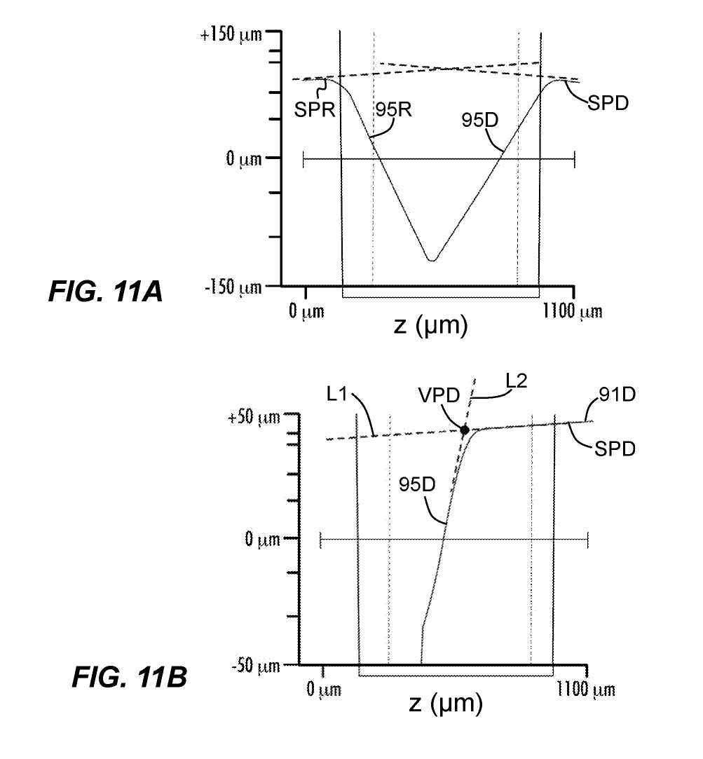

FIG. 11A shows a profile taken for two LC connector ferrules 90R and 90D mated beneath the scanning laser profilometer Here the V-shaped profile formed by the two mated ferrule end bevels 95 is clearly visible. Unlike the single ferrule profile in FIGS. 10A and 10B, the profile of the mated ferrules does not suddenly drop off partway down the bevel 95. This may be due to better alignment of the laser profilometer directly over the axis of the mated ferrules 90.

The two ferrule angles θ_{R} and θ_{D} can be determined by performing a linear interpolation along the profile for each ferrule outside-surface edge 91. By subtracting the two measured ferrule angles, the relative ferrule-to-ferrule angle θ_{C} can be determined as discussed above. This ferrule angle measurement can be performed accurately because of the high accuracy of the scanning laser profilometer measurement, i.e., 0.1 μm.

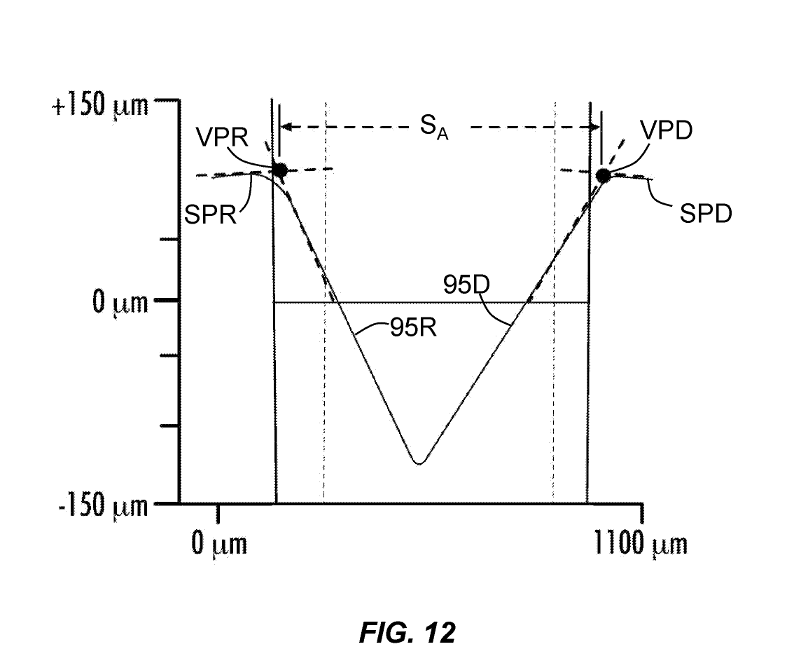

Unlike the vision system measurement, the scanning laser profilometer can also make accurate measurements of ferrule lateral misalignment, e.g., to within 0.1 μm. Ferrule outer-surface edge position estimates can be made directly using a few profilometer measurements at a fixed location along the outer-surface edge 91. Alternatively, a virtual reference point VPR can be generated by determining the intersection point between a line extrapolated from the ferrule outer-surface edge 91 and a line extrapolated from the ferrule end bevel 95, as discussed above and as shown in FIG. 11B. When virtual reference points VPR and VPD are generated for mated ferrules 90R and 90D, an estimate of the ferrule gap distance d can be made that can have an accuracy of about 1 μm. FIG. 12 is similar to FIG. 11A and illustrates the determination of two virtual reference points VPR and VPD, along with the estimated ferrule-to-ferrule separation distance SA as determined from the two virtual reference points VPR and VPD.

A tradeoff to consider for the laser profilometer system is the measurement time versus the measurement accuracy. Measurement error can be reduced via time and spatial averaging of measurement signals, with highest accuracy measurements requiring multiple (e.g., 8-16) scans to average out measurement noise.

In an example, a relatively short (e.g., 1 mm) scanning distance limit may make it difficult to characterize ferrule coaxial misalignment for two closely spaced SC ferrules without additional refinements. This is a particular problem for APC (Angle Polished Connector) ferrules 90, where the bevel 95 can extend a large axial distance (e.g., >1 mm) away from the ferrule end face 92. One solution is to mount the scanning laser profilometer on a precision motion stage and translate the profilometer between the two ferrules, in a manner similar to the technique described above for vision systems with limited field of view.

Thus, in an example embodiment, the laser scanning profilometer is mounted on a precision translation stage that moves perpendicular to the profilometer scan sweep direction to make 2D scans of the measurement region where the confronting ferrules 90R and 90D reside. These scans can reveal the relative orientations of the reference and DUT ferrules 90R and 90D, indicating how they are rotated in θₓ and θ_{y} relative to each other. The scans can also indicate the x and y lateral offsets δx and δy between the two ferrules, as well as the gap distance d. Once the ferrule relative misalignments are known, the precision motion stages can be actuated so that the two ferrules 90R and 90D are brought into coaxial or paraxial alignment.

Since the laser scanning process is relatively slow, the methods disclosed herein may benefit from using either of the optical methods described above to rapidly pre-align the reference and DUT ferrules 90R and 90D. This pre-alignment can reduce the size of the scanning region, thereby reducing total scan time.

If both reference and DUT ferrules 90R and 90D have a known diameter profile and eccentricity, they can be measured via a single scan and then provide the required lateral, angular and axial alignment steps to bring them into coaxial alignment near contact. But since the ferrule diameters are not generally known exactly, in an example laser scans from two or more equally spaced azimuthal directions can be taken to improve measurement accuracy. This requirement increases the measurement time unless multiple scanning laser profilometers are employed to cover the different viewing directions.

### Active Coaxial Alignment Until Near-Contact Axial Separation

An aspect of the systems and methods disclosed herein includes performing active coaxial alignment until the reference and DUT ferrules 90R and 90D are nearly in contact. The measurement techniques for ferrule coaxial alignment described above can also be used to determine the gap distance d. The methods provide different accuracies for ferrule gap distance estimation and measurement acquisition times, and they can be employed separately or together as the ferrules move closer to one another.

The '133 application describes methods for estimating a ferrule contact position P_{C} by measuring how the coupled power changes as the two connector ferrules 90R and 90D slide within a passive alignment sleeve. The main difference between the passive alignment approach of the '133 application and the active alignment approach described herein is that the reference ferrule 90R is coaxially aligned to the DUT ferrule 90D as the ferrule gap distance d is reduced using active alignment process that acts as a type of virtual alignment sleeve. Thus, the need for an alignment sleeve is obviated using the systems and methods described herein.

The reference ferrule 90R can be coaxially aligned to the DUT ferrule 90D at a large gap distance d using one of the approaches described above. Once this is accomplished, the gap distance d between the two ferrules 90R and 90D can reduced through coordinated translational motion of the stage 80 without having to perform rotations in θₓ and θ_{y}.

Since the reference and DUT ferrule end faces 92R and 92D are parallel after coaxial alignment, all the position monitoring approaches based on fringes of the insertion loss versus gap distance d as described in the '133 application can be leveraged in the present methods. If it becomes important to eliminate or at least reduce the influences of fringes during ferrule gap distance reduction, a slight angular misalignment can be introduced between the two connector ferrule end faces 92R and 92D, e.g., by rotating the reference ferrule 90R slightly in θₓ or θ_{y}. The influence of this slight angular rotation of the reference ferrule 90R on optical coupling can be compensated through simple modification of the equations governing contact-point prediction to include angular misalignment losses.

If in a previous alignment step the DUT ferrule 90D was rotated in θₓ and θ_{y} so that its axis is parallel to the reference connector z axis of stage 80, then after coaxial alignment of the reference ferrule 90R to the DUT ferrule 90D, the gap distance d can be reduced by simply translating the reference stage 80 along the z-axis. This configuration simplifies position control during gap reduction by eliminating any position errors arising from lack of perfect synchronization of motion of the three x-y-z axis actuators of stage 80. It also mimics the alignment configuration described in the '133 application for the near-contact measurement of the insertion loss by replacing the passive alignment of the ceramic sleeve with active alignment via the precision motion of stage 80. In both configurations, motion of a single precision z-axis stage is used to capture the insertion loss data and estimate the ferrule gap distance d.

The sleeveless, active-alignment approach has several advantages over the sleeved passive-alignment approach, including:
Avoids position hysteresis due to the mechanical decoupling of the connector ferrule from the ferrule body via the axial spring is eliminated, since the ferrule is gripped firmly by a mounting fixture.
Avoids position variations and grip and slip errors due to friction between the ferrule and the alignment sleeve.
No contamination from debris collecting on the inside surface of the alignment sleeve.
No unpredictable variations in lateral position and angular rotation during ferrule gap reduction due to the ferrules contacting the inside surface of the alignment sleeve.

To improve the performance of the active alignment process, the reference and DUT ferrule outer surfaces 91R and 91D and their respective end faces 92R and 92D should be cleaned to prevent debris and contamination from influencing ferrule outer-surface edge measurements and smooth ferrule axial motion when the ferrule gap distance is extremely small, e.g. 5 μm.

Using the contact-prediction algorithm described in the '133 application, the ferrule gap distance d can be reduced to the point where the ferrules nearly touch, e.g., to a gap distance of d=5 μm. At this point, the relative positions of the reference and DUT ferrules 90R and 90D can be measured using the coaxial alignment methods described above. If the reference and DUT ferrules 90R and 90D have become laterally misaligned during the ferrule gap reduction process, they can be realigned at this point. Since lateral misalignments will alter the shape of the insertion loss curve, it may be beneficial to repeat the insertion loss measurements at the near-contact position after the reference and DUT ferrules 90R and 90D have been laterally aligned.

### Reducing Axial Separation Using Vision System Feedback

The '133 application discloses the use of a vision system to estimate the gap distance d. This approach is not expected to yield ferrule gap distance estimates with sub-micrometer accuracy, but can be used to indicate when the gap distance d is less than a target value to within a few micrometers. It can therefore be used to flag when the approaching reference and DUT ferrules 90R and 90D reach a sufficiently small gap distance (e.g., 20 μm). At this point, the methods described in the '133 application can be used to estimate DUT connector IL based on IL measurements made near contact.

### Reducing Axial Separation Using Laser Profilometer Feedback

As noted above, the position resolution of the laser profilometer of viewing system 204 of PMS 200 can be as small as 1 μm. Consequently, small changes in ferrule gap distance d can be detected if the laser scan path traverses features on both the reference and DUT ferrules 90R and 90D. For example, the measured profile of the ferrule end face perimeter bevel 95 provides an indication of the location of ferrule end face 92. In particular, the two edge locations where the bevels 95 meets the ferrule end face 92 and the ferrule outer surface 91 can be detected using the laser profilometer. These edge locations appear as corner and discontinuity features in the measured profiles that occur at specific scan positions. When the reference and DUT ferrules 90R and 90D approach one another, these features change their position in the profile scans.

One challenge with this approach is that the locations of bevels 95 are not well-defined relative to the ferrule end 92. This is because ferrule bevel polish region lengths varies considerably from ferrule to ferrule, and because convex ferrule end polishing operations result in a curved end face profile wherein the height of the curved end face region varies from ferrule to ferrule.

Thus, in an example, these geometrical variations can be characterized for each ferrule 90 so that scanned ferrule edge profile feature positions can be used to predict ferrule gap distance d. For example, the laser profilometer can be directed at the ferrule bevel 95 or ferrule end face 92 from a direction normal to the surface so that accurate measurements of bevel lengths and ferrule end face heights can be made. Alternatively, a vision system can be used to characterize these geometrical features. The characterization of these geometrical features can then be used to improve the measurement accuracy of the insertion loss measurement of the DUT connector 70D.

### Detecting Error Conditions

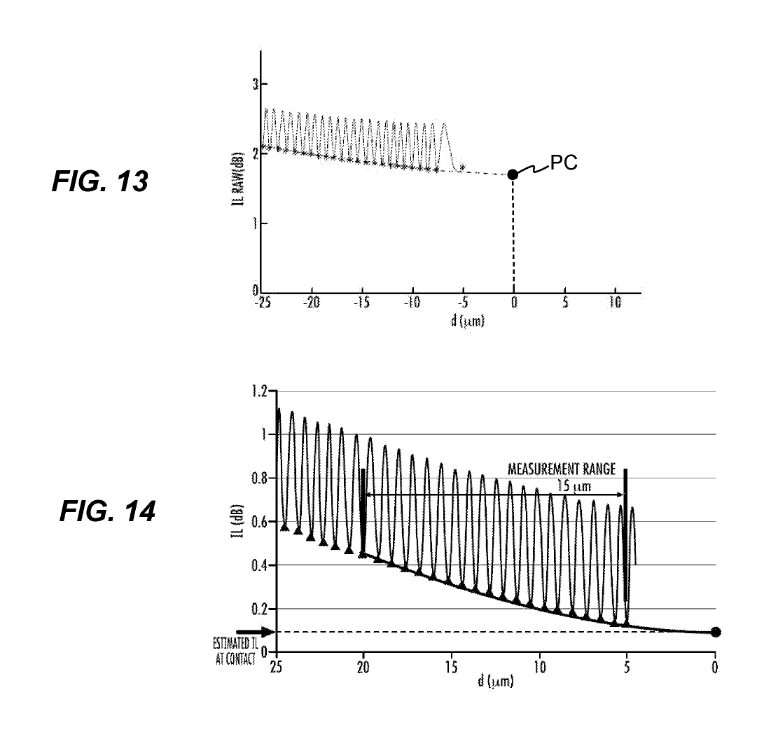

System 10 is capable of detecting errors over the course of an insertion loss measurement. System 10 can at least reduce if not mitigate such errors by either prompting the operator for a repeat measurement or automatically implementing a repeat measurement. Example errors include: a) no light observed, indicating a possible dark fiber; b) extremely high insertion loss, indicating a possible end face contamination or bad jumper; and c) a gradual change in the fringe period immediately before ferrule-to-ferrule contact, indicating possible end face contamination, where contamination is gradually compressed under ferrule end face pressure. FIG. 13 is a plot of the measured insertion loss IL (dB) versus gap distance d (μm) illustrating how contamination on the ferrule end face 92 can change the periodicity of the IL fringe pitch. Depending on the severity of the detected IL error, an operator may be prompted to re-clean a connector 70 or to reject a failed jumper cable.

Once the ferrule gap distance d is very close to contact (e.g., a 5-20 μm gap distance d), measurements are conducted to estimate the DUT connector insertion loss IL. In the simplest approach, the ferrule gap distance d is reduced to the minimum separation distance (e.g., d=5 μm) and an insertion loss measurement is made. FIG. 14 is similar to FIG. 13 and illustrates a parabolic curve fit for estimating DUT insertion loss IL at contact using a set of near-contact IL minima points and an extrapolation of the measurements using a parabolic curve fit to the estimated contact point where d=0.

### Repeat Measurements

After an insertion loss measurement cycle is completed using system 10, reference ferrule 90R is retracted away from the near contact ferrule gap position. If system 10 determines that repeat measurements are required to correct detected errors or to improve measurement accuracy, the reference ferrule 90R is only partially retracted. The partial retraction provides a sufficient ferrule gap distance d to make another fine estimate of ferrule contact position (typically 70-100 μm stage travel) and provides sufficient ferrule gap distance to make another near contact DUT IL estimate (typically about 30 μm of stage travel).

Since the active alignment methods disclosed herein do not require the use of a passive alignment device such as a ceramic alignment sleeve, there are no hysteresis effects to overcome relating to partial compression of the connector resilient member 100. This reduces the required retraction distance, enabling repeat measurements to be implemented more quickly than for passive alignment methods. A typical retraction distance is about 100 μm, so for stage velocities of 0.1 to 1.0 mm/sec, the additional measurement cycle time required for retraction is 1 to 0.1 seconds, respectively.

### Error Detection

As noted above, measurement system 10 is capable of detecting errors over the course of a measurement. Feedback from non-contact optical methods for determining the reference ferrule position as described above can also be used to confirm that the reference ferrule 90R and the DUT ferrule 90D have remained in coaxial alignment during the process of reducing ferrule gap distance. For example, system 10 employing optical coupled power feedback can detect a rapid change in the insertion loss that does not correlate to the change in ferrule gap distance d as expected due to the motion of stage 80. The system 10 can then actively re-peak the coupled power via stage positioning adjustments to bring the reference and DUT ferrules 90R and 90D back into coaxial alignment.

In another example where system 10 employs vision system feedback via PMS 200, a lateral shift in the position of reference ferrule 90R can be detected and system 10 can actively adjust the reference ferrule lateral offset to bring both the reference and DUT ferrules 90R and 90D back into coaxial alignment. The system 10 can perform this function continuously as the ferrule gap distance d is reduced.

In another example, system 10 employing a scanning laser profilometer in PMS 200 can detect a lateral shift in the position of reference ferrule 90R and actively adjust the reference ferrule lateral offset to bring both the reference and DUT ferrules 90R and 90D back into coaxial alignment. The system 10 can perform this function continuously as the ferrule gap distance d is reduced.

In an example where ferrules 90R and 90D becomes laterally misaligned, system 10 can actively compensate for rapidly changing shifts in ferrule position. This makes system 10 more tolerant to vibrations and minor drifts in ferrule position, which can be due to how the ferrule is supported on stage 80, vibration due to resilient member 100, or ambient system vibrations due to lack of isolation. In an example, system 10 is configured using known techniques in the art to reduce or mitigate these sources of ferrule position misalignment.

### Multiple Measurements for Improved Accuracy

Multiple insertion loss measurements on the same DUT connector 70 can be used to improve measurement accuracy by discarding or averaging out outlier measurements. Since most of the measurement cycle is spent determining the ferrule contact position P_{C} as opposed to performing fine measurements of the DUT insertion loss, repeat insertion loss measurements can be performed rapidly with minimal influence on the measurement cycle. Multiple measurements can be programmed to be performed for every DUT connector measurement, for some sampled subset of DUT connector measurements, or after certain error events are detected.

After all measurements on a given DUT connector 70D are completed, the reference ferrule 90R is partially retracted and then the operator of system 10 is instructed to remove the DUT connector from system 10. Since no passive alignment sleeve is required, if the connector 68D on the opposite end of the jumper cable 60D has not yet been measured, it can now be measured.

### Measurement Scope

In the example embodiments described herein, the DUT connector 70D is shown as an optical connector located at one end of an optical jumper cable 60D by way of example and for ease of illustration. It should be understood that the DUT connector insertion loss measurement methods using active alignment as presented herein are broadly applicable to connectors located on any optical component, including passive optical devices such as 1:2 and 1:N splitters, combiners, tap monitors, WDM (Wavelength Division Multiplexer) filters, gain flattening filters, AWG (Arrayed Waveguide Grating) multiplexers and demultiplexers, polarizers, isolators, circulators. It can also be applied to active optical devices, such as 1×N optical switches, laser sources, SOAs (Semiconductor Optical Amplifiers), fiber-based amplifiers, VOAs (Variable Optical Attenuators) and modulators.

Furthermore, the systems and methods disclosed herein have been described based on light being coupled in one direction between two optical connectors 70R and 70D. However, the systems and methods can be applied to single-port devices, such as photodetectors and MEMS (Micro-Electro-Mechanical System)-based retroreflective VOAs (Variable Optical Attenuators). In these devices, the measurement may be implemented in a bidirectional reflective mode, using a circulator for both launching an optical interrogation signal into the single port device and for capturing a reflected signal that contains information on how much light was coupled in the DUT connector. Time-Domain Reflectometry may be useful for distinguishing light back-reflected off the DUT ferrule end face from light reflected off optical elements internal to the single-port device.

The systems and methods disclosed herein are applicable to any kind of connector, including SC and LC connectors, MTP and MT-RJ connectors, and polished flat (UPC) or angled (APC) connectors. Furthermore, the optical fiber 62 can be either single-mode or multimode.

In an example, system 10 can be designed to automatically measure connector insertion loss for two DUT connectors 70D at the same time. For example, instead of having a dedicated measurement port and detector port PM and PD, system 10 can have two ports, port A and port B. The operator would insert the first jumper cable connector into port A and the second jumper cable connector into port B. Then the measurement system would measure the insertion loss for the first connector, followed by the insertion loss for the second connector.

In an example, the reference connector fixture 82 and stage 80 can be mounted on one movable platform (not shown), while the broad-area detector 40-2 for measuring the amount of light coupled through the DUT jumper cable 60D can be mounted on a second movable platform.

The reference connector fixture 82 and stage 80 and the broad area detector 40-2 can also be mounted on a common platform. The common platform can be a rotary stage or carousel that reverses the positions of the two measurement components, or a linear stage that slides back and forth to be aligned as needed. In the latter case, it would be necessary to duplicate one of the measurement components (either the reference connector mount and stage or the broad-area detector) so that the linear motion would result in alignment of the appropriate type measurement component with a given jumper cable connector.

This configuration has the benefit of reducing overall connector insertion loss measurement cycle time, since the operator of system 10 would need to handle the DUT jumper cable 60D during mounting and removal half as many times as in the previous case. The configuration is well-suited for measurements techniques that separately estimate jumper cable fiber link insertion loss and connector insertion loss, since the various measurements could all be easily correlated to each other for the single DUT jumper cable mounted in system 10.

As described above, the near-contact insertion loss measurement approach is also applicable to multimode fiber connectors and APC connectors.

### Integrated Features

The system 10 can be configured in a variety of ways to improve throughput, simplify component handing, and/or boost component yield. For example, immediately after DUT jumper cable connector insertion into system 10, a visual ferrule end inspection can be carried out to examine the fiber and ferrule end faces for contamination and damage. If contamination is detected, system 10 can either stop the measurement and recommend removal of the problem connector and re-clean its ferrule end face, or it can be configured to automatically clean the ferrule end face 92. Systems for inspecting and cleaning ferrule end faces 92 can be mounted using the same mounting features described above for double-ended DUT jumper cable connector measurements.

In another example, system 10 can be configured to support the measurement of complex optical components, such as 1:N splitters, that may involve large numbers of connectors. The component and its connectors can be mounted in a common cassette or fixture so that individual connector pairs can be characterized automatically by selecting specific connectors and inserting or aligning them to the aforementioned front panel measurement and detector ports.

### Core-to-Ferrule Lateral Misalignment

An advantage of the active alignment systems and methods disclosed herein is that system 10 may be used for estimating the core-to-ferrule lateral misalignment. To perform this function, system 10 is configured to determine the relative positions of the two connector ferrule outer-surface edges 91R and 91D to within 0.1 μm to 0.2 μm. The core-to-ferrule misalignment measurement can be implemented by first bringing both ferrules 90R and 90D to a near-contact ferrule gap distance, such as 5 μm. This can be accomplished following any of the non-contact approaches described above. At this point, the ferrules 90R and 90D can be laterally aligned to each other in one of two ways. A first way involves ferrule coaxial alignment, where both ferrules 90R and 90D are aligned so that they share a common geometrical axis, but where optical power between the connector fibers is not necessarily at a maximum. A second way involves fiber core lateral alignment, where optical power between the connector fibers 62R and 62D is at a maximum, but where the ferrules are not necessarily coaxially aligned.

Depending on how the ferrules and fibers are aligned, stage 80 is moved laterally to determine core-to-ferrule misalignment. For example, if the ferrules 90R and 90D are coaxially aligned (first case above), the reference ferrule 90R is moved laterally using stage 80 until optical power between the connector fibers 62R and 62D is peaked. The distance that stage 80 moves laterally in the x and y directions provides a measurement of core-to-ferrule misalignment. If the fiber cores are laterally aligned so that optical power is at a maximum (the second case above), then the reference ferrule 90R is moved laterally until system 10 detects that the connector ferrules 90R and 90D are coaxially aligned. The distances moved laterally in the x- and y-directions provide a measurement of core-to-ferrule misalignment.

In both cases, it is assumed that the reference connector core-to-ferrule lateral misalignment has been previous characterized. Any known core-to-ferrule lateral misalignment can be subtracted from the x and y direction lateral motions described above to provide an accurate estimate of measurement of core-to-ferrule misalignment. Measurements can be repeated multiple times to confirm results and possibly improve accuracy via measurement averaging.

### Grading Connectors Based on Industry Standards

SC and LC connectors 70 may be graded based on their optical coupling performance and their core-to-ferrule lateral alignment. The IEC (International Electrotechnical Commission) standards are industry standards that define acceptance regions for core-to-ferrule lateral misalignment for UPC and APC connectors for Grade B-D connectors. In particular, IEC 61755-3-1 outlines the geometry requirements for SC and LC PC (Physical Contact) connectors, while IEC 61755-3-2 outlines the geometry requirements for SC and LC APC (Angled Physical Contact) connectors. These standards are key-shaped for Grade B and C connectors and circular for Grade D connectors.

Since system 10 can be configured to measure core-to-ferrule misalignment, it can employ the above-identified industry standards to automatically grade optical connectors based on the core-to-ferrule misalignment measurement and the previously estimated connector IL.

In field deployment, the measured connector 70 will be mated with another connector that can also be characterized by a given performance grade. Since the variation in insertion loss with fiber-to-fiber lateral misalignment is known, one can predict how the connector insertion loss would vary as the connector is mated with a connector of any other grade. This can be accomplished via simulation wherein the lateral misalignment is estimated between fiber core of the measured connector and the fiber core of a theoretical mating connector, wherein the fiber core falls within the core-to-ferrule lateral misalignment acceptance region. The simulation is performed for each possible fiber core position over the acceptance region, yielding the following results for simulated coupling to a connector with a given grade.
Expected maximum IL value
Expected minimum IL value
Probability distribution function of IL values based on uniform distribution of mating fiber core-to-ferrule lateral misalignments within grade specification
Probability distribution function (PDF) of IL values based on measured distribution of mating fiber core-to-ferrule lateral misalignments within grade specification, where the measured distribution of core-to-ferrule lateral misalignment is likely non-uniform and based on a sufficiently large population of manufactured connectors for a given grade.

The last option includes the effect of removing connectors located near the centers of the core-to-ferrule acceptance regions that were selected as higher grade connectors.

Instead of simulating the mated connector insertion loss, one can also directly measure the connector insertion loss using system 10. This is done by laterally misaligning the reference connector 70R so that its fiber core position sufficiently samples positions within the acceptance region for a given connector grade. While this approach can be more time consuming because many measurements are required at many lateral offset positions, it is expected to yield a more accurate result since it is based on actual connector insertion loss measurements instead of theoretical estimates, which do not include the effects of any geometrical features or defects that specific to the DUT connector 70D. A similar set of measurement values (maximum IL, minimum IL and IL PDF, connector grade) can be returned by system 10.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

1. A non-contact method of measuring an insertion loss of a device-under-test (DUT) connector having a first ferrule with a first optical fiber and a first end face with a reference connector having a second ferrule with a second optical fiber and a second end face, comprising:
axially aligning the first and second ferrules so that the first and second end faces are confronting and spaced apart to define a gap with an axial gap distance d;
measuring values of the insertion loss between the first and second optical fibers for different gap distances d>0 μm while actively maintaining alignment of the first and second ferrules using a position measurement system; and
estimating a value for the insertion loss for a gap distance of d=0 μm based on the measured values of the insertion loss when d>0 μm.

2. The method according to claim 1, wherein the position measurement system includes a viewing system that comprises either a vision system or a laser profilometer.

3. The method according to claim 2, wherein the viewing system views the first and second ferrules over a measurement region, and including moving the viewing system to increase the measurement region.

4. The method according to claim 2, wherein the vision system captures an image of the first and second ferrules, and further including performing image processing on the captured image to determine at least one of an angular misalignment between the first and second ferrules and the gap distance d.

5. The method according to claim 2, wherein the laser profilometer measures a profile of the first and second ferrules, and further including processing the image profile to determine at least one of an angular misalignment between the first and second ferrules and the gap distance d.

6. The method according to claim 1, wherein the DUT connector is one selected from the group of connectors comprising: SC, LC, MTP, MT-RJ, UPC and APC.

7. The method according to claim 1, further comprising calculating a contact position of the reference connector where the first and second end faces are expected to come into contact.

8. The method according to claim 7, wherein calculating the insertion loss includes using an extrapolation of the measured values of the insertion loss to the contact position.

9. The method according to claim 1, wherein the first and second optical fibers are either both single-mode fibers or both multimode fibers.

10. The method according to claim 1, wherein the DUT connector is part of a jumper cable having a second connector and the first optical fiber, and further including measuring an insertion loss of the second connector.

11. A non-contact method of measuring an insertion loss of a device-under-test (DUT) connector having a first ferrule with a first optical fiber and a first end face with a reference connector having a second ferrule with a second optical fiber and a second end face, comprising:
a) arranging the reference and DUT connectors so that the first and second end faces of the first and second ferrules are confronting and spaced apart to define an adjustable gap with an adjustable axial gap distance d;
b) moving the reference and DUT connectors so that the first and second ferrules approach one other, thereby reducing the gap distance d;
c) during said moving, i) measuring values of the insertion loss between the first and second optical fibers for the different gap distances d>0, and ii) actively maintaining alignment of the first and second ferrules;
determining a contact position at which the first and second ferrule end faces would come into contact without actually bringing the first and second ferrule end faces into contact; and
estimating a value for the insertion loss at the determined contact position based on the measured values of the insertion loss for the different gap distances.

12. The method according to claim 11, wherein actively maintaining the alignment of the first and second ferrules includes viewing the first and second ferrules with a vision system.

13. The method according to claim 12, wherein said viewing includes capturing images of the first and second ferrules, and further including performing image processing on the captured images to determine at least one of a lateral misalignment, an angular misalignment and the gap distance.

14. The method according to claim 11, wherein actively maintaining the alignment of the first and second ferrules includes capturing profiles the first and second ferrules with a laser profiling system.

15. The method according to claim 14, wherein said viewing includes capturing profiles of the first and second ferrules, and further including processing the captured profiles to determine at least one of a lateral misalignment, an angular misalignment and the gap distance.

16. The method according to claim 11, wherein estimating a value for the insertion loss includes identifying insertion loss minima and performing an extrapolation of the minima to the contact position.
